(19) United States
(12) Patent Application Publication
(10) Pub. No.: US 2024/0241523 A1
(43) Pub. Date: Jul. 18, 2024

(54) INFORMATION PROCESSING APPARATUS, COMMUNICATION SYSTEM, SPECIFYING METHOD, AND NON-TRANSITORY COMPUTER READABLE MEDIUM

(71) Applicant: NEC CORPORATION, Minato-ku, Tokyo (JP)

(72) Inventors: Shinya YASUDA, Tokyo (JP); Hiroshi Yoshida, Tokyo (JP); Taichi Kumagai, Tokyo (JP); Masayuki Murata, Osaka (JP); Yuichi Ohsita, Osaka (JP)

(73) Assignee: NEC CORPORATION, Minato-ku, Tokyo (JP)

(21) Appl. No.: 18/684,248

(22) PCT Filed: Jan. 19, 2022
(86) PCT No.: PCT/JP2022/001832

§ 371 Date: Feb. 16, 2024

(30) Foreign Application Priority Data
Aug. 31, 2021 (JP) 2021-140626

(51) Int. Cl. G05D 1/622; G05D 1/246; G05D 1/65; G05D 107/70

(52) U.S. Cl. CPC G05D 1/622; G05D 1/2464; G05D 1/65; G05D 2107/70

(57) ABSTRACT

An information processing apparatus according to the present disclosure includes, a communication unit configured to receive observation data from at least one sensor, the observation data being obtained by observing an obstacle in a plurality of areas, a determination unit configured to determine presence/absence of an obstacle in the plurality of areas by using the observation data, and a specifying unit configured to specify, when the presence/absence of an obstacle in a first area included in the plurality of areas is unknown, a probability of presence of an obstacle in the first area by using a determination result indicating presence/absence of an obstacle in an area near the first area, in which the probability changes depending on presence/absence of an obstacle in the area near the first area.

### TECHNICAL FIELD

The present disclosure relates to an information processing apparatus, a communication system, and a specifying method.

### BACKGROUND ART

In recent years, the number of cases where autonomously-travelling conveyance robots perform work in factories or warehouses is increasing. In such factories, a plurality of conveyance robots are travelling and a plurality of people are working. Therefore, there has been a demand for control for preventing such autonomously-travelling conveyance robots from colliding with other conveyance robots or people.

In Patent Literature 1, it is stated that dynamic map information is generated by reflecting (i.e., adding) positions of obstacles such as people in static map information, which is configured with a 2D (two-dimensional) or 3D (three-dimensional) grid for each floor of a building, based on position information of the obstacles such as people obtained from monitoring cameras or motion sensors. An autonomous mobile body control apparatus controls an autonomous mobile body (e.g., an autonomous vehicle) so as to prevent it from colliding with an obstacle by using such dynamic map information.

### CITATION LIST

### Patent Literature

Patent Literature 1: International Patent Publication No. WO2018/189770

### SUMMARY OF INVENTION

### Technical Problem

In Patent Literature 1, dynamic map information is generated in which it is presumed there is a certain probability of the presence of an obstacle in a space the monitoring camera cannot monitor, namely a blind spot. However, when it is presumed that there is a certain probability of the presence of an obstacle in a space the monitoring camera cannot monitor, namely, a blind spot, the autonomous mobile body control apparatus needs to perform control so as to prevent the autonomous mobile body from travelling through the space which is the blind spot even when there is actually no obstacle in the space. Further, in the case where there is actually an obstacle in the space the monitoring camera cannot monitor namely, a blind spot, if the probability of the presence of an obstacle is set to a low value, the autonomous mobile body could collide with the obstacle. As described above, there is a problem that, depending on the state of the installation of the monitoring camera, it is not possible to determine an appropriate travelling route for the autonomous mobile body.

An object of the present disclosure is to provide an information processing apparatus, a communication system, and a specifying method capable of generating control information for determining an appropriate travelling route for an autonomously-travelling mobile body.

### Solution to Problem

An information processing apparatus according to a first aspect of the present disclosure includes, a communication unit configured to receive observation data from at least one sensor, the observation data being obtained by observing an obstacle in a plurality of areas; a determination unit configured to determine presence/absence of an obstacle in the plurality of areas by using the observation data; and a specifying unit configured to specify, when the presence/absence of an obstacle in a first area included in the plurality of areas is unknown, a probability of presence of an obstacle in the first area by using a determination result indicating presence/absence of an obstacle in an area near the first area, wherein the probability of the presence of an obstacle in the first area changes depending on presence/absence of an obstacle in the area near the first area.

A communication system according to a second aspect of the present disclosure includes: a sensor configured to observe an obstacle in a plurality of areas and transmit observation data indicating a result of the observation; determination means for determining presence/absence of an obstacle in the plurality of areas by using the observation data; and specifying means for specifying, when the presence/absence of an obstacle in a first area included in the plurality of areas is unknown, a probability of presence of an obstacle in the first area by using a determination result indicating presence/absence of an obstacle in an area near the first area, wherein the probability of the presence of an obstacle in the first area changes depending on presence/absence of an obstacle in the area near the first area.

A specifying method according to a third aspect of the present disclosure includes: receiving observation data from at least one sensor, the observation data being obtained by observing an obstacle in a plurality of areas; determining presence/absence of an obstacle in the plurality of areas by using the observation data; and specifying, when the presence/absence of an obstacle in a first area included in the plurality of areas is unknown, a probability of presence of an obstacle in the first area by using a determination result indicating presence/absence of an obstacle in an area near the first area, wherein the probability of the presence of an obstacle in the first area changes depending on presence/absence of an obstacle in the area near the first area.

### Advantageous Effects of Invention

According to the present disclosure, it is possible to provide an information processing apparatus, a communication system, and a specifying method capable of generating control information for determining an appropriate travelling route for an autonomously-travelling mobile body.

### BRIEF DESCRIPTION OF DRAWINGS

FIG. 1 is a configuration diagram of an information processing apparatus according to a first example embodiment;

FIG. 2 is a configuration diagram of a communication system according to the first example embodiment;

FIG. 3 shows a flow of a calculation process according to the first example embodiment;

FIG. 4 is a configuration diagram of a control system according to a second example embodiment;

FIG. 5 shows grid data reflecting information indicating presence/absence of an obstacle according to the second example embodiment;

FIG. 6 is a diagram for explaining an example of calculation when a probability of presence of an obstacle in a grid where presence/absence of an obstacle is unknown according to the second example embodiment;

FIG. 7 shows a flow of a process for determining a moving route of a mobile body according to the second example embodiment;

FIG. 8 shows grid data in which time is taken into consideration according to a third example embodiment;

FIG. 9 shows labels in respective grids according to the third example embodiment;

FIG. 10 is a configuration diagram of a control apparatus according to a fourth example embodiment;

FIG. 11 shows a travelling area of a mobile body according to the fourth example embodiment;

FIG. 12 shows a travelling area of a mobile body according to the fourth example embodiment;

FIG. 13 shows a moving route of a mobile body according to the fourth example embodiment;

FIG. 14 shows a speed pattern of a mobile body according to the fourth example embodiment; and

FIG. 15 shows a configuration diagram of a control apparatus according to a respective example embodiment.

### EXAMPLE EMBODIMENT

### First Example Embodiment

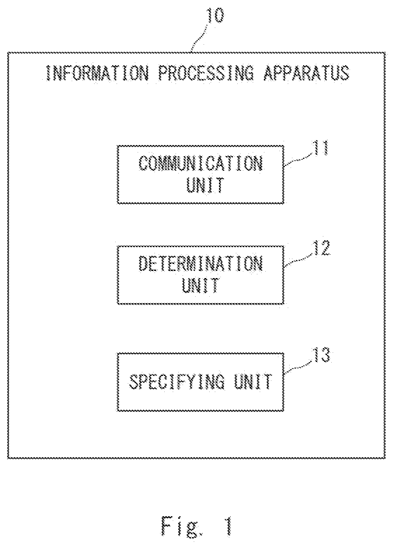

An example embodiment according to the present disclosure will be described hereinafter with reference to the drawings. An example of a configuration of an information processing apparatus 10 according to a first example embodiment will be described with reference to FIG. 1. The information processing apparatus 10 may be a computer apparatus that operates as a processor executes a program stored in a memory.

The information processing apparatus 10 includes a communication unit 11, a determination unit 12, and a specifying unit 13. The communication unit 11, the determination unit 12, and the specifying unit 13 may be software or a module(s) by which processing is performed by having a processor execute a program stored in a memory. Alternatively, the communication unit 11, the determination unit 12, and the specifying unit 13 may be hardware such as circuitry or a chip.

The communication unit 11 receives, from at least one sensor, observation data obtained by observing an obstacle(s) in a plurality of areas in a predetermined space. The sensor may be, for example, a sensor for detecting an object or a person which is regarded as being an obstacle in the predetermined space. The object that is regarded as being an obstacle may be, for example, an apparatus, equipment, a shelf, a column, or the like disposed in the predetermined space. Further, the object that is regarded as being an obstacle may be a moving object or a stationary object. The sensor may be, for example, a camera or an infrared sensor. The camera may be a 2D camera or a 3D camera. The sensor may be a 2D Lidar or a 3D Lidar. Instead of just one camera sensor, a plurality of cameras or sensors may be mounted in respective positions in order to observe the predetermined space.

The observation data may be, for example, depth data indicating a distance from the sensor to an object or a person present in the predetermined space, or may be photograph data (or video data) in the case where a camera is used as the sensor. The depth data and photograph data (or video data) may be referred to as image data.

The predetermined space may be, for example, an area that is monitored by at least one sensor. Alternatively, the predetermined space may be, for example, an area in which a mobile body (e.g., a vehicle) travels. The plurality of areas in the predetermined space may be divided areas obtained by dividing the predetermined space. Further, each of the areas included in the plurality of areas may have an area (e.g., a sub-area) that overlaps other areas. The plurality of areas may be indicated by using 2D information or by using 3D information. One sensor may observe a plurality of areas, and a plurality of sensors may observe one area. Alternatively, one sensor may observe one area.

The determination unit 12 determines presence/absence of an obstacle in the plurality of areas by using the observation data. For example, the determination unit 12 may determine whether or not there is an obstacle in each of the areas by performing image recognition processing or image analysis processing by using image data such as photograph data (or video data) or depth data.

A case where presence/absence of an obstacle in a first area included in the plurality of areas is unknown will be described hereinafter. In this case, the specifying unit 13 calculates a probability of presence of an obstacle in the first area by using the result of the determination on the presence/absence of an obstacle in an area near the first area.

For example, in the case where a sensor detects an obstacle in a predetermined space, it may be determined that presence/absence of an obstacle is unknown in a blind spot of the sensor. Alternatively, it may be determined that presence/absence of an obstacle is unknown due to the position or the like of the obstacle. Alternatively, it may be determined that presence/absence of an obstacle is unknown due to, for example, the material of the obstacle or the environment or the like around the obstacle. The environment around the obstacle may be, for example, an illuminance, a humidity, or a temperature.

The area near the first area where presence/absence of an obstacle is unknown may be, for example, an area adjacent to the first area or an area located a predetermined distance away from the first area. The probability of presence of an obstacle in the first area changes depending on presence/absence of an obstacle in a nearby area. Note that the influence of the nearby area on the probability of the presence of an obstacle in the first area may increase as the nearby area is closer to the first area.

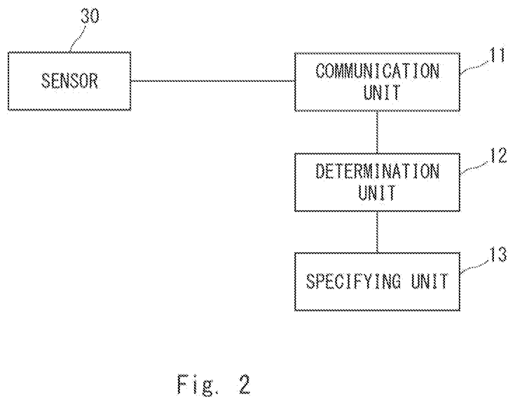

Next, an example of a configuration of a communication system according to the first example embodiment will be described with reference to FIG. 2. The communication system shown in FIG. 2 includes a sensor 30, a communication unit 11, a determination unit 12, and a specifying unit 13. Although it is shown that the communication unit 11 communicates with one sensor 30 in FIG. 2, the communication unit 11 may communicate with two or more sensors 30. Further, the communication unit 11 may communicate with a plurality of sensors 30 through a network. Further, the communication unit 11, the determination unit 12, and the specifying unit 13 may not be provided in one information processing apparatus 10. For example, the communication unit 11, the determination unit 12, and the specifying unit 13 may be distributed over apparatuses different from each other, or two of the communication unit 11, the determination unit 12, and the specifying unit 13 may be disposed in the same apparatus.

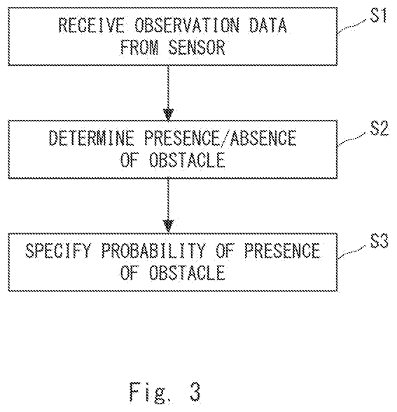

Next, a flow of a calculation process performed in the information processing apparatus 10 according to the first example embodiment will be described with reference to FIG. 3. Firstly, the communication unit 11 receives, from at least one sensor 30, observation data obtained by observing an obstacle(s) in a plurality of areas in a predetermined space (S1). Next, the determination unit 12 determines presence/absence of an obstacle (i.e., determines whether or not there is an obstacle) in the plurality of areas by using the observation data (S2). Next, when the presence of an obstacle in the first area included in the plurality of areas unknown, the specifying unit 13 specifies a probability of presence of an obstacle in the first are by using a determination result indicating presence/absence of an obstacle in an area near the first area (S3). Note that the probability of the presence of an obstacle in the first area changes depending on presence/absence of an obstacle in an area near the first area.

As described above, the information processing apparatus 10 determines presence/absence of an obstacle by using observation data obtained by an observation by a sensor. Then, when the determination result indicates that the presence/absence of an obstacle is unknown, the information processing apparatus 10 calculates a probability of presence of an obstacle in the area where the presence/absence of an obstacle is unknown. The information processing apparatus 10 calculates the probability of the presence of an obstacle in the area where the presence/absence of an obstacle is unknown by using a determination result indicating presence/absence of an obstacle in an area near the area where the presence/absence of an obstacle is unknown. In this way, the information processing apparatus 10 can accurately calculate the probability of the presence of an obstacle in the predetermined space. As a result, the information processing apparatus 10 can provide information about the presence of an obstacle as control information with which a mobile body determines an appropriate travelling route when the mobile body autonomously travels in the predetermined space. Note that in the case where the probability of presence of an obstacle in an area where whether presence/absence of an obstacle is unknown is set to a fixed value, it becomes difficult to set an appropriate value as the probability of the presence of an obstacle, so that the accuracy of the value set as the probability of the presence of an obstacle deteriorates. In contrast, the information processing apparatus 10 calculates the probability of presence of an obstacle in an area where presence/absence of an obstacle is unknown by using a determination result indicating presence/absence of an obstacle in an area near the area where the presence/absence of an obstacle is unknown. In this way, the information processing apparatus 10 can set an appropriate value as the probability of the presence of an obstacle in the area where whether the presence/absence of an obstacle is unknown, rather than setting a fixed value as the probability of the presence of an obstacle.

### Second Example Embodiment

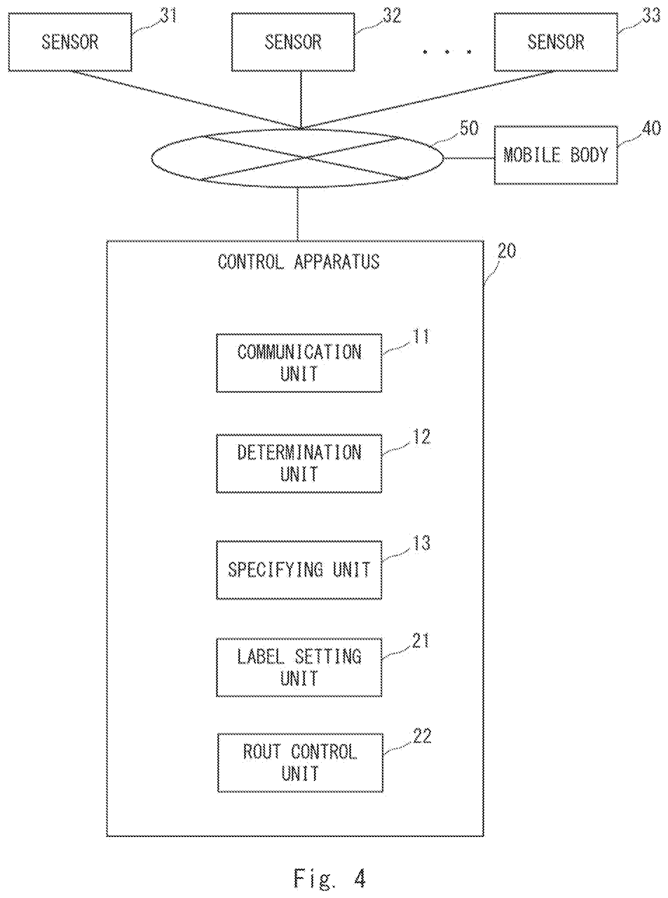

Next, an example of a configuration of a control system according to a second example embodiment will be described with reference to FIG. 4. In the control system shown in FIG. 4, a control apparatus 20, sensors 31 to 33, and a mobile body 40 communicate with each other through a network 50. The control apparatus 20 corresponds to the information processing apparatus 10 shown in FIG. 1. The control apparatus 20 controls the moving route of the mobile body. The mobile body 40 may be an autonomously-moving robot. The robot may be, for example, a conveyance robot (e.g., an AGV (Automated Guided Vehicle)) that conveys an object to be conveyed. The mobile body 40 autonomously moves in a travelling area while avoiding an obstacle based on obstacle information generated by the control apparatus 20.

The sensors 31 to 33 detects an object or a person which is regarded as being an obstacle in the predetermined space. Each of the sensors 31 to 33 may be, for example, a camera apparatus. For example, the sensors 31 to 33 periodically photographs (i.e., takes still images or moving images of) the travelling area in which the mobile body 40 travels, and transmits the photograph data (i.e., obtained still images or moving images) to the control apparatus 20 through the network 50. The photograph data may be 2D data or 3D data. The 2D data may be, for example, image data. The 3D data may include image data and distance data indicating a distance from the sensor to the object. The photograph data corresponds to the observation data.

The control apparatus 20 has a configuration that is obtained by adding a label setting unit 21 and a route control unit 22 to the configuration of the information processing apparatus 10 shown in FIG. 1. The label setting unit 21 and the route control unit 22 may be software or a module(s) by which processing is performed by having a processor execute a program stored in a memory. Alternatively, the label setting unit 21 and the route control unit 22 may be hardware such as circuitry or a chip.

The communication unit 11 receives photograph data (or video data) from the sensors 31 to 33 through the network 50. The sensors 31 to 33 generate photograph data (or video data) that is obtained by photographing (or taking a moving image of) a part of the travelling area or the whole travelling area. The determination unit 12 determines presence/absence of an obstacle in the travelling area photographed by the sensors 31 to 33. The determination unit 12 may synthesize or combine the photograph data obtained by the sensors 31 to 33 (e.g., three pieces of photograph data obtained by the sensors 31 to 33, respectively), and thereby generate map data showing the whole travelling area. The map data is image data showing the whole travelling area. Further, the determination unit 12 generates grid data that is obtained by dividing the map data into a plurality of sections (hereinafter also referred to as a plurality of cells), and determines or specifies whether or not there is an obstacle in each cell of the grid, or whether the presence/absence of an obstacle is unknown. The grid data may be, for example, data obtained by dividing the map data so that 10 pixels of the image data correspond to one cell of the grid. Alternatively, the grid data may be data obtained by dividing the map data at predetermined intervals (e.g., intervals of one meter) set by a user, or data obtained by appropriately dividing the map data through machine learning (e.g., dividing the map data according to the average size of baggage or the like). Alternatively, the grid data may be data obtained by dividing the map data so that the total number of cells of the grid becomes a predetermined number. Further, the map data does not necessarily have to be divided into square cells, and may be divided into rectangular cells, circular cells, elliptical cells, or cells each having a predetermined shape.

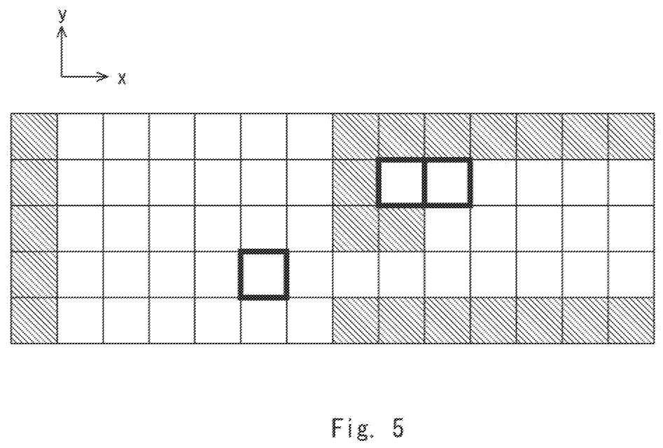

FIG. 5 shows grid data in which information indicating presence/absence of an obstacle is reflected (i.e., in which presence/absence of an obstacle is indicated). FIG. 5 shows grid data that is generated based on photograph data that is obtained by photographing the travelling area from above by using the sensors 31 to 33 installed on the ceiling or the like. Although FIG. 5 shows a grid (i.e., cells of a grid) obtained by dividing a 2D plane extending in X- and Y-directions, the determination unit 12 may generate grid data obtained by dividing a 3D space. In FIG. 5, hatched cells of the grid represent cells in which there is an obstacle, and cells surrounded by bold lines represent those in which presence/absence of an obstacle is unknown. Further, the other cells of the grid represent those in which there is no obstacle.

Whether there is an obstacle or not in each cell of the grid may be determined, for example, by performing machine learning. For example, in the case where a learning model is generated in advance through learning of images or the like of obstacles and the floor surface, the determination unit 12 may determine whether or not there is an obstacle in each cell of the grid by applying the learning model to the grid data. For example, the determination unit 12 may determine that there is no obstacle in cells of the grid in each of which the floor surface is shown, and may determine that there is an obstacle in cells of the grid in each of which the floor surface is not shown. The determination unit 12 may determine that presence/absence of an obstacle in a cell of the grid is unknown when the floor surface is shown in that cell but the ratio of the area (i.e., the size) of the floor surface in the cell to the entire area of the cell (i.e., the size of the cell itself) is smaller or larger than a predetermined threshold. Further, in the case where a learning model is applied to the grid data, the determination unit 12 may determine that presence/absence of an obstacle in a cell of the grid is unknown when an obstacle is included in the cell but its name or the like cannot be specified.

Alternatively, when the photograph data is 3D data and the grid data contains distance data from the sensor to objects, the determination unit 12 may determine that there is an obstacle in an area for which the distance data indicates a distance different from those for nearby areas. Further, the determination unit 12 may determine that presence/absence of an obstacle is unknown in an area of which the distance from a nearby area is equal or shorter than a predetermined threshold. The determination unit 12 may determine whether or not there is an obstacle by performing an edge detection process for the grid data.

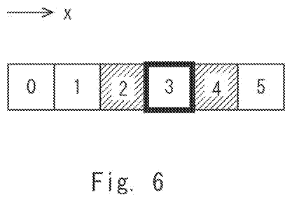

The specifying unit 13 calculates, for each of cells of the grid where it is determined that the presence/absence of an obstacle is unknown, a probability of presence of an obstacle in that cell. An example of calculation of a probability of presence of an obstacle in a cell of the grid in which it is determined that the presence/absence of an obstacle is unknown, performed by the specifying unit 13 will be described hereinafter with reference to FIG. 6. In this example, in order to facilitate the explanation, an example of calculation using 1D (one-dimensional) grid data in which cells are arranged (i.e., are lined up) in the X-direction will be described. FIG. 6 shows that Cell_0 to Cell_5 are arranged in the X-direction. Each of the numbers shown in the cells shown in FIG. 6 is identification information for identifying a respective one of the cells of the grid. Cell_0, Cell_1, and Cell_5 indicate that there is no obstacle therein. Cell_2 and Cell_4 indicate that there is an obstacle therein. Cell_3 indicates that the presence/absence of an obstacle therein is unknown.

The specifying unit 13 calculates a probability of presence of an obstacle in Cell_3 by using the below-shown Expressions 1 and 2.

$$q ( x ) = \frac{1}{z} exp ( E ( x ) ) \qquad ( 1 )$$

$$E ( x ) = \sum {P}_{i} ( {x}_{i} \vert {o}_{i} ) + \sum {P}_{ij} ( {x}_{i} {x}_{j} \vert {o}_{i} {o}_{j} ) \qquad ( 2 )$$

In Expression 2, E(x) is an expression for calculating a degree or weight indicating a likelihood of x. Expression 1 is an expression for converting the weight E(x) into a probability q(x) of the occurrence of x. Note that x is a number, a vector or the like, and represents an example of the realization (or occurrence) of a probability event. Z represents the sum of all the conceivable exp(E(x)).

For example, assume that x is either 1 or 2. Further, assuming that it is known that E(1)=1 and E(2)=2, Z is calculated as Z=exp(E(1))+exp(E(2))=exp(1)+exp(2)=10.107. In this case, the probability q(x=1) of x being equal to 1 (x=1) is expressed as q(1)=exp(E(1))/Z=0.2689, i.e., is calculated as about 27%.

Note that regarding Cell_0 to Cell_5, there are 64 combinations of them in each of which there is an obstacle or no obstacle in each of the cells. E(x) is calculated for each of these 64 combinations. For example, for a combination in which there is no obstacle in any of Cell_0 to Cell_5. E(x) is expressed as E(absent, absent, absent, absent, absent, absent), and for a combination in which there is an obstacle only in Cell_3, it is expressed as E(absent, absent, absent, present, absent, absent).

Note that Pᵢ(xᵢ|oᵢ) in the first term of Expression 2 represents a weight for putting a label xᵢ when the determination result of a Cell_i (i is an integer from 0 to 5) is oᵢ. The determination result indicates that there is an obstacle, indicates that there is no obstacle, or indicates that presence/absence of an obstacle is unknown. For example, when there is an obstacle, it is expressed as “present”; when there is no obstacle, it is expressed as “absent”; and when presence/absence of an obstacle is unknown, it is expressed as “unknown”. A label for each cell of the grid indicates information that is set when it is determined whether or not there is an obstacle in that cell. For example, for each cell of the grid, when it is determined that there is an obstacle in that cell, “present” is set for the cell, and when it is determined that there is no obstacle in that cell, “absent” is set for the cell. For each cell of the grid for which it is determined that presence/absence of an obstacle is unknown, a label “present” or “absent” is set for that cell.

Pᵢⱼ(xᵢxⱼ|oᵢoⱼ) in the second term of Expression 2 represents a weight for putting labels xᵢ and xⱼ when the determination results of two cells i and j adjacent to each other (j is an integer from 0 to 5 and different from i) are o and oⱼ, respectively. Although an example in which two cells i and j adjacent to each other are used is shown here, the weight for putting labels may be expressed by using determination results of three or more consecutively-arranged cells in the second term of Expression 2. Alternatively, a third term may be added to Expression 2, so that the weight for putting labels may be expressed by using determination results of three or more consecutively-arranged cells in the third term. The use of determination results of four or more consecutively-arranged cells is similar to the above-described use of determination results of three or more consecutively-arranged cells.

Further, it is assumed that the following rules are applied to the determination of weights. Firstly, regarding Pᵢ(xᵢ|oᵢ), when the determination result is “present”, the weight for putting a label “present” is set as Pᵢ(present|present)=1. Further, when the determination result is “present”, the weight for putting a label “absent” is set as Pᵢ(absent|present)=0. Further, the weights are set as Pᵢ(absent|absent)=1 and Pᵢ(present|absent)=0. Further, when the determination result is unknown, the weights are set as Pᵢ(present|unknown)=1 and Pᵢ(absent|unknown)=1. Alternatively, the weights may be set as Pᵢ(present|unknown)=1 and Pᵢ(absent|unknown)=0.5. As described above, when the determination result is unknown, it is possible to increase the probability of a determination that there is an obstacle by making a difference between the weight for putting a label “present” and the weight for putting a label “absent”. By increasing the probability of the determination that there is an obstacle, the safety for the travelling route of the mobile body 40 can be increased. Alternatively, the weights may be set as Pᵢ(present|unknown)=0.5 and Pᵢ(absent|unknown)=1. In this way, it is possible to increase the probability of the determination that there is no obstacle. By increasing the probability of the determination that there is no obstacle, a more efficient travelling route for the mobile body 40 can be set (i.e., established). The efficient travelling route may be, for example, a short moving route for the mobile body 40.

Alternatively, an optimal value for the weight may be calculated through machine learning or the like. For example, data indicating presence/absence of an obstacle in each cell of the grid as shown in FIG. 6 may be prepared as test data for which a correct answer is known. The test data may also be referred to as, for example, correct answer data or teacher data. Further, an evaluation value indicating a quantity obtained by quantifying the goodness between a prediction result predicted from a probability field (or a random field) expressed by using Expressions 1 and 2 and the like, and correct answer data may be determined, and then the weight with which the evaluation value is maximized may be determined. Note that a plurality of candidates for weights may be prepared, and for each of the weights, an evaluation value when that weight is used may be calculated. Then, a weight with which the evaluation value is maximized may be selected.

Next, regarding Pᵢⱼ (xᵢxⱼ|oᵢoⱼ), when unknown is not included in the determination result, the weight for putting a label according to the determination result is set to 1, and the other weights are set to 0. Further, in the case where unknown is included in the determination result, when the determination results of two Cell_i and Celli adjacent to each other are (present, unknown) or (unknown, present), the weight for putting a label (present, present) is set to 1, and the other weights are set to 0. That is, Pᵢⱼ(present, present|present, unknown)=Pᵢⱼ (present, present|unknown, present)=1. Further, in the case where unknown is included in the determination result, when the determination results of two Cell_i and Celli adjacent to each other are (absent, unknown) or (unknown, absent), the weight for putting a label (absent, absent) is set to 1, and the other weights are set to 0. That is, Pᵢⱼ(absent, absent|absent, unknown)=Pᵢⱼ(absent, absent|unknown, absent)=1.

For example, when a label (absent, absent, absent, absent, absent, absent) is put on the determination result of the cells 0 to 5 (absent, absent, present, unknown, present, absent), it is calculated as E(absent, absent, absent, absent, absent, absent)=4+1=5. Further, when a label (absent, absent, absent, absent, absent, absent) is put on the observation data of the cells 0 to 5 (absent, absent, present, unknown, present, absent), it is calculated as E(absent, absent, absent, absent, absent, present)=3+1=4. In this way, when the calculation is performed 64 times, which is the total number of label combinations, the label arrangement (i.e., label combination) for which the value of E(x) is the largest is calculated as E(absent, absent, present, present, present, present, absent)=6+5=11. That is, for the determination result of the cells 0 to 5 (absent, absent, present, unknown, present, absent), a label combination (absent, absent, present, present, present, present, absent) is the most likely label pattern, i.e., is the most reliable label pattern.

Note that for the determination result of the cells 0 to 5 (absent, absent, present, unknown, present, absent), a probability q that the cell 3 is labeled with “present” (i.e., a probability q that Cell_3=present), i.e., a probability q that it is determined that there is an obstacle in the cell 3 (Cell_3=present), is calculated by using the below-shown Expression 3.

$$q ( Cell\_ 3 = present ) = {\sum }_{a 0 = present , absent} {\sum }_{a 1 = present , absent} {\sum }_{a 2 = present , absent} {\sum }_{a 4 = present , absent} {\sum }_{a 5 = present , absent} q ( a 0 , a 1 , a 2 , present , a 4 , a 5 ) \qquad ( 3 )$$

The result of the calculation of Expression 3 is 0.8607, so that it is calculated that the probability of the presence of an obstacle in Cell_3 is about 86%. Although 1D grid data has been described with reference to FIG. 6, it is also possible to calculate 2D grid data in a similar manner. In the case of 2D grid data, the specifying unit 13 calculates a probability of presence of an obstacle in a cell where presence/absence of an obstacle is unknown by using grid data in which cells are arranged in the X- and Y-directions. Specifically, the specifying unit 13 uses grid data in which cells including those in each of which presence/absence of an obstacle is unknown are arranged in the X-direction, and grid data in which cells including those in each of which presence/absence of an obstacle is unknown are arranged in the Y-direction.

Further, in addition to calculating the probability that Cell_3 where presence/absence of an obstacle is unknown is labeled with “present”, a probability that a cell where the determination result is “absent” or “present” is labeled with, for example, “present” may be calculated. By doing so, even when there is an error in the determination result, it can be corrected to an appropriate calculation result by calculating a probability of presence of an obstacle. Specifically, there are cases where when it is determined whether or not there is an obstacle in each cell of the grid, it is mistakenly determined that there is an obstacle in a cell where there is actually no obstacle due to an error in photograph data or the like. In such a case, it is possible to detect an error in the determination result by calculating a probability of presence of an obstacle by using a determination result(s) in a nearby cell(s).

Referring to FIG. 4 again, the label setting unit 21 sets a label to each cell of the grid shown in FIG. 5. The label setting unit 21 sets a label indicating that there is an obstacle in each of the cells where it has been determined that there is an obstacle. Further, the label setting unit 21 sets a label indicating that there is no obstacle in each of the cells where it has been determined that there is no obstacle.

For each of the cells where it is determined that presence/absence of an obstacle is unknown, the label setting unit 21 determines a label to be set by using the probability of presence of an obstacle calculated in the specifying unit 13. For example, the label setting unit 21 may set a label indicating that there is an obstacle when the probability of presence of an obstacle exceeds a predetermined threshold, and may set a label indicating that there is no obstacle when it is equal to or lower than the threshold. Alternatively, the label setting unit 21 may set the value of the probability of the presence of an obstacle as a label.

The route control unit 22 controls the moving route of the mobile body 40 by using the labels set by the label setting unit 21. Specifically, the route control unit 22 may control the route of the mobile body 40 so as to prevent the mobile body 40 from travelling in any of the cells where there is an obstacle. The route control unit 22 determines the moving route of the mobile body 40 and transmits information about the determined moving route to the mobile body 40 through the network 50. Further, the route control unit 22 may transmit information about the control of the driving unit of the mobile body 40 to the mobile body 40 so that the mobile body 40 travels along the determined moving route. The information about the control of the driving unit may be, for example, information about a moving speed of each wheel including an angular speed thereof. Further, the route control unit 22 may transmit information about the posture (or attitude) of the mobile body 40 so that the body of the mobile body 40 does not tilt. Further, the route control unit 22 may transmit information about the angle at which the mobile body 40 pushes the object to be conveyed so that the mobile body 40 does not release or drop the object to be conveyed. Further, in the case where the mobile body 40 conveys the object to be conveyed in cooperation with another mobile body(ies), the route control unit 22 may transmit information about a distance between the mobile body 40 and the other mobile body to the mobile body 40.

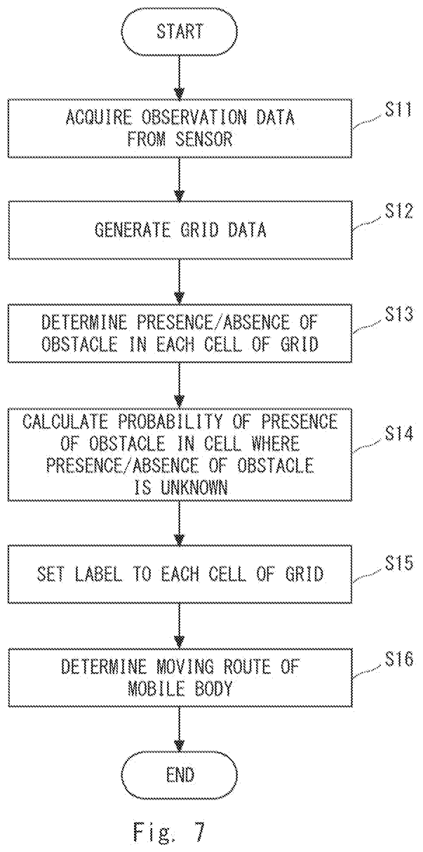

Next, a flow of a process for determining the moving route of the mobile body 40 according to the second example embodiment will be described with reference to FIG. 7. Firstly, the communication unit 11 receives observation data generated by the sensors 31 to 33 (i.e., three pieces of observation data generated by the sensors 31 to 33, respectively) (S11). The observation data may be, for example, photograph data (or video data) generated by the sensors 31 to 33 (i.e., three pieces of photograph data generated by the sensors 31 to 33, respectively).

Next, the determination unit 12 generates grid data by using the received observation data (S12). The determination unit 12 may generate map data showing the whole travelling area for the mobile body 40 by combining a plurality of pieces of observation data, and then generate grid data by dividing the map data into a plurality of cells.

Next, the determination unit 12 determines whether or not there is an obstacle in each of the cells of the grid shown in the grid data (S13). For example, the determination unit 12 may determine whether or not there is an obstacle in each of the cells of the grid by using a learning model that has learned images or the like of obstacles and the floor surface.

The specifying unit 13 calculates, for each of the cells of the grid where it is determined that presence/absence of an obstacle is unknown, a probability of presence of an obstacle in that cell of the grid (S14). In the case of 2D grid data, for example, the specifying unit 13 calculates a probability of presence of an obstacle in each of such cells by using grid data in which cells are arranged in the X- and Y-directions.

Next, the label setting unit 21 sets, for each of the cells where it is determined that presence/absence of an obstacle is unknown as a result of the determination as to the presence/absence of an obstacle, a label to that cell by using the probability of the presence of an obstacle in that cell (S15). The label to be set may be, for example, a label indicating that there is an obstacle or a label indicating that there is no obstacle.

Next, the route control unit 22 determines the moving route of the mobile body 40 by using the label set to each cell of the grid (S16). For example, the route control unit 22 may determine the moving route of the mobile body 40 so as to prevent the mobile body 40 from travelling along a route in which there is an obstacle.

As described above, the control apparatus 20 calculates, for each of cells where presence/absence of an obstacle is unknown, a probability of presence of an obstacle in that cell by using information indicating presence/absence of an obstacle in a cell near that cell. That is, the control apparatus 20 calculates a probability of presence of an obstacle for missing data. By taking the situation of a cell near the cell where presence/absence of an obstacle is unknown into consideration, the weight of the presence of an obstacle in that cell is taken into consideration, so that the accuracy of the calculated probability can be improved.

### Third Example Embodiment

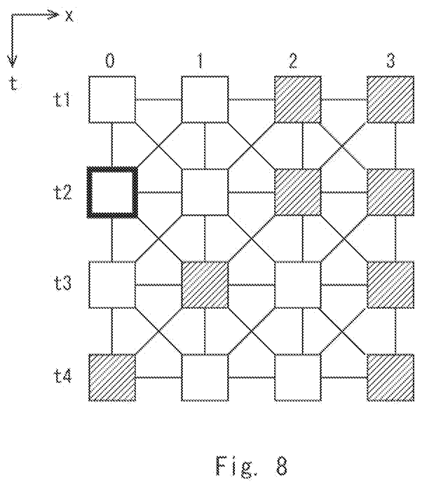

Next, grid data in which time or a time series is taken into consideration will be described with reference to FIG. 8. FIG. 8 shows grid data in which cells are arranged in the X-direction and grid data in which cells are arranged in a time series manner (e.g., a chronological order). Each of the numbers shown in FIG. 8 is identification information identifying a respective one of the cells of the grid. Further, each of times t1 to t4 indicates a time. FIG. 8 shows whether or not there is an obstacle in each of Cell_0 to Cell_4 at each of times t1 to t4.

At the time t1, it is shown that there is no obstacle in Cell_0 and Cell_1, and there is an obstacle in each of Cell_2 and Cell_3. At the time t2, it is shown that presence/absence of an obstacle in Cell_0 is unknown; there is no obstacle in Cell_1; and there is an obstacle in each of Cell_2 and Cell_3. At the time t3, it is shown that there is no obstacle in Cell_0 and Cell 2, and there is an obstacle in each of Cell_1 and Cell_3. At the time t4, it is shown that there is no obstacle in Cell_1 and Cell 2, and there is an obstacle in each of Cell_0 and Cell_3.

The communication unit 11 receives the observation data (e.g., a plurality of pieces of observation data) generated at the times t1 to t4 from the sensors 31 to 33, and the determination unit 12 generates grid data (e.g., a plurality of pieces of grid data) by using the received observation data and arranges the grid data (i.e., the plurality of pieces of grid data) in a time series manner (i.e., a chronological order). As a result, the grid data shown in FIG. 8 is generated. Note that the grid data does not necessarily have to be arranged in a time series manner, it may be sufficient if such grid data is generated while taking its time series into consideration. The sensors 31 to 33 periodically generates observation data. The sensors 31 to 33 may set, to the generated observation data, a time stamp indicating a timing, a time, or the like at which the observation data was generated. The determination unit 12 may check the time stamp and thereby arrange the grid data in a time series manner. The sensors 31 to 33 generate observation data (e.g., generate their respective observation data) at substantially the same timing as each other. In other words, the sensors 31 to 33 synchronize the timings at which they generate observation data with each other.

The specifying unit 13 calculates a probability of presence of an obstacle in Cell_0 at the time t2, at which (i.e., in which cell and at which time) it is shown that the presence/absence of an obstacle is unknown. For example, there are 256 combinations of 16 cells in total, i.e., from Cell_0 to Cell_3 and from the time t1 to time t4, in each of which there is an obstacle or no obstacle in each of the cells. The specifying unit 13 calculates E(x) for each of these 256 combinations by using Expression 2. Note that when the specifying unit 13 calculates a weight by using two cells adjacent to each other in the second term of Expression 2, it uses cells that are vertically, horizontally, or diagonally adjacent to each other in FIG. 8.

Further, the specifying unit 13 calculates a probability q that Cell_0 is labeled with “present” at the time t2 (time t2 and Cell_0=present) by using Expressions 1 and 3.

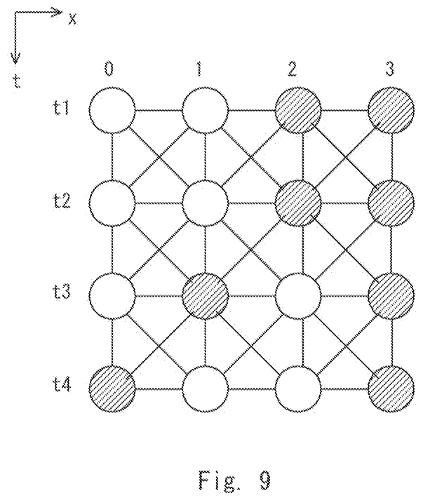

The label setting unit 21 sets the labels of Cell_0 to Cell_3 at the times t1 to t4 by using the probability calculated by the specifying unit 13 and the determination result as to presence/absence of an obstacle in each cell of the grid. FIG. 9 shows a label in each cell of the grid set by the label setting unit 21. In FIG. 8, the label setting unit 21 sets a label indicating that there is an obstacle in each of the cells where it is determined that there is an obstacle, and sets a label indicating that there is no obstacle in each of the cells where it is determined that there is no obstacle. Further, FIG. 9 shows that the label setting unit 21 sets a label indicating that there is no obstacle in Cell_0 at the time t2, at which (i.e., in which cell and at which time) it has been determined that presence/absence of an obstacle is unknown. For example, the label setting unit 21 sets a label indicating that there is an obstacle when the probability of the presence of an obstacle exceeds a predetermined threshold, and sets a label indicating that there is no obstacle when the probability of the presence of an obstacle is equal to or lower than the threshold.

The route control unit 22 controls the moving route of the mobile body 40 by using the labels set by the label setting unit 21. Note that the label setting unit 21 may determine whether an obstacle is moving or at a standstill by using the labels set thereto.

For example, the label setting unit 21 increases the number of types of labels set to each cell of the grid. For example, the label setting unit 21 sets the label to “Standstill” when there is a stationary obstacle, sets the label “Absent” when there is no obstacle, sets the label “Left” when there is an obstacle moving to the left, and sets the label “Right” when there is an obstacle moving to the right. In this case, the number of combinations of 16 cells of the grid in each of which: there is a stationary obstacle; there is no obstacle; there is an obstacle moving to the left; or there is an obstacle moving to the right, is the 16th power of 4 (=4,294,967,296). The specifying unit 13 calculates E(x) for each of these combinations, the number of which is 16th power of 4, by using Expression 2. Further, the specifying unit 13 increases the number of combinations of weights used in the second term of Expression 2. For example, when the determination results of Cell_x at a time t and Cell_x−1 at a time t+1, which are diagonally adjacent to each other, are (present, present), the specifying unit 13 sets the weight for putting a label (left, left) to 1. That is, the specifying unit 13 sets the weight as Pᵢⱼ(left, left|present, present)=1 for the two cells, i.e., Cell_i=(x,t) and Cell_j=(x−1, t+1), which are diagonally adjacent to each other. Further, the specifying unit 13 sets the weight as Pᵢⱼ(right, right|present, present)=1 for the two cells, i.e., Cell_i=(x,t) and Cell_j=(x+1, t+1), which are diagonally adjacent to each other. Further, the specifying unit 13 may set weights that are used when unknown is included in the determination result, such as setting the weight as Pᵢⱼ(left, left|present, unknown)=1 for the two cells, i.e., Cell_i=(x, t) and Cell_j=(x−1, t+1), which are diagonally adjacent to each other. Further, when the determination results of Cell_x at a time t and Cell_x at time t+1 are (present, present), the weight for putting a label (standstill, standstill) may be set to 1. That is, the specifying unit 13 may set the weight as Pᵢⱼ(standstill, standstill|present, present)=1 for the two cells, i.e., Cell_i=(x, t) and Cell_j=(x, t+1). By using Expressions 1 and 3, the specifying unit 13 calculates a probability that there is a stationary obstacle, a probability that there is no obstacle, a probability of the presence of an obstacle moving to the right, or a probability of the presence of an obstacle moving to the left in each cell of the grid. Note that when the number of labels increases, the amount of calculation performed in the specifying unit 13 increases. Therefore, the specifying unit 13 may perform approximate calculation by using a probability propagation method (belief propagation).

The label setting unit 21 determines a label to be set to each cell of the grid by using a respective one of the probabilities calculated by the specifying unit 13.

The route control unit 22 sets the route of the mobile body 40 so as to avoid (e.g., go around) moving obstacles and stationary obstacles.

Further, the specifying unit 13 calculates a probability of presence of an obstacle even when there is no observation data, and the label setting unit 21 may set labels according to the calculation result. For example, the determination unit 12 determines whether or not there is an obstacle by using observation data for each cell of the grid up to the time t4. At and after the time t5, the specifying unit 13 calculates a probability of presence of an obstacle in each cell of the grid by using the grid data and the determination result that are obtained before and at the time t4. For example, the specifying unit 13 calculates a probability of presence of an obstacle in Cell_0 at the time t5 by using the grid data from the time t1 to the time t5 under the assumption that the grid data in Cell_0 at the time t5 is the grid data indicating that the presence/absence of an obstacle is unknown. Further, the specifying unit 13 may calculate the probability of presence of an obstacle in Cell_0 at the time t5 by using the grid data of Cell_1 at the time t4, which is grid data of a cell located diagonally with respect to Cell_0 at the time t5.

As described above, the label setting unit 21 can update the label to be set to each cell of the grid as the time elapses. In this way, the label setting unit 21 can determine whether there is a stationary obstacle or a moving obstacle in each cell of the grid. The route control unit 22 can prevent the mobile body 40 from colliding with an obstacle by setting the route while taking stationary obstacles and moving obstacles into consideration.

Further, the specifying unit 13 can calculate a probability of presence of an obstacle in each cell of the grid at a given time in the future for which it has received no observation data. In this way, the route control unit 22 can set a long-term moving route for the mobile body 40.

### Fourth Example Embodiment

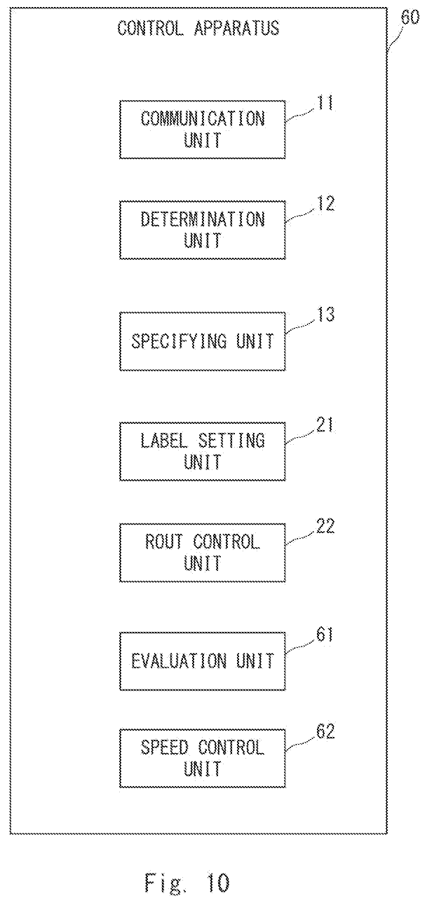

Next, an example of a configuration of a control apparatus 60 according to a fourth example embodiment will be described with reference to FIG. 10. The control apparatus 60 has a configuration that is obtained by adding an evaluation unit 61 and a speed control unit 62 to the configuration of the control apparatus 20 shown in FIG. 4. In the following description, the differences between the control apparatus 60 and the control apparatus 20 will be mainly described, and the functions and configurations similar to those of the control apparatus 20 will not be described in detail.

The evaluation unit 61 evaluates safety that is presumed under the assumption that the mobile body 40 moves along the route set by the route control unit 22. In some cases, the mobile body 40 meanders rather than moving exactly along the route set by the route control unit 22. For example, the mobile body 40 may meander due to external environmental conditions such as the condition of the ground surface which the mobile body 40 is in contact with and climatic conditions, or internal environmental conditions such as the aging state of the mobile body 40. The evaluation unit 61 calculates a score that indicates whether or not the mobile body 40 can travel safely by taking a probability that the mobile body 40 does not travel exactly along the set route. The evaluation unit 61 calculates the score in such a manner that the more the probability that the mobile body 40 collides with an obstacle decreases, the higher the score becomes.

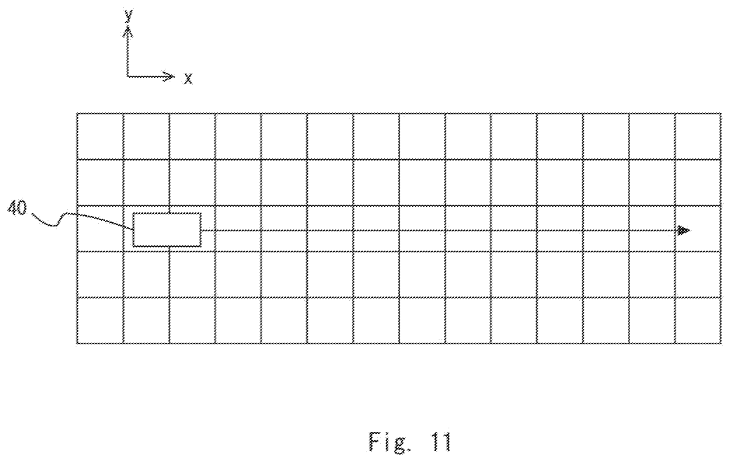

FIG. 11 shows a travelling area for the mobile body 40. Specifically, FIG. 11 shows an area when the travelling area for the mobile body 40 is viewed from above in a direction perpendicular to the 2D area corresponding to the travelling area for the mobile body 40. In FIG. 11, it is shown that the mobile body 40 is moving in a straight line in the X-direction exactly along the route set by the route control unit 22.

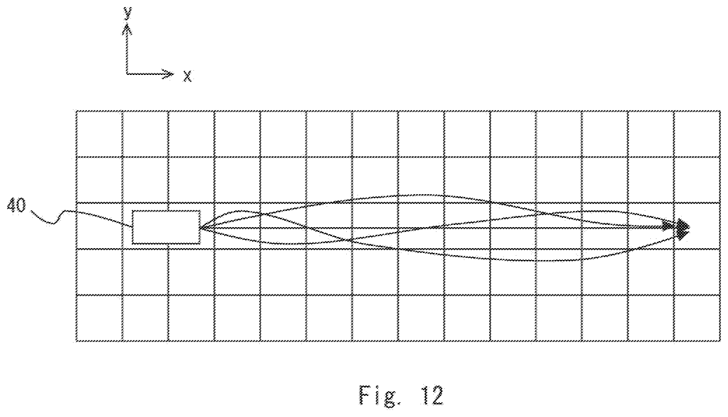

Meanwhile, FIG. 12 shows that the mobile body 40 is travelling in a meandering manner rather than exactly along the route set by the route control unit 22. FIG. 12 shows a plurality of routes in each of which the mobile body 40 meanders, i.e., shows variation patterns of the route. As shown in FIG. 12, a probability model that shows that the mobile body 40 does not necessarily move along the set route is expressed by the below-shown Expression 4.

$$dr = f ( r , u ) dt + {SdB}_{t} \qquad ( 4 )$$

The expression r=(x,y,θ) is a vector representing the state of the robot. The symbol f represents a function describing the dynamics of the robot. The symbol u represents a control input. The symbol S represent a variance matrix. The symbol dBₜ represents an increase in Brownian motion in a minute time. Expression 4 shows that, when the function f(r,u) is given, SdBₜ, which indicates the probabilistic influence that is caused when the mobile body 40 meanders, is added to dr=f(r,u)dt, which indicates the position of the cell that changes according to the time change dt. That is, Expression 4 shows variations of the position of the cell where the mobile body 40 is present at a certain time or a certain timing. In other words, Expression 4 shows the variation patterns of the route shown in FIG. 12.

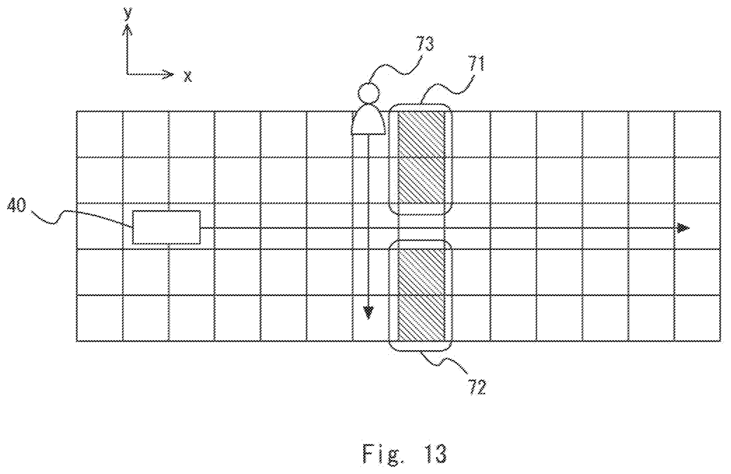

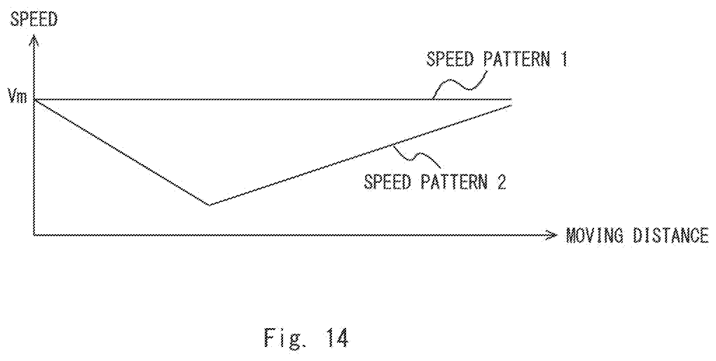

An example of calculation of a score performed by the evaluation unit 61 will be described hereinafter with reference to FIGS. 13 and 14. FIG. 13 shows that the mobile body 40 moves so as not to collide with any of stationary obstacles 71 and 72 and a moving obstacle 73. Each of the stationary obstacles 71 and 72 may be, for example, a wall, and the moving obstacle 73 may be, for example, a walking person. An arrow attached to the moving obstacle 73 indicates the moving route of the obstacle 73. Further, an arrow attached to the mobile body 40 indicates the moving route of the mobile body 40 which is set so that the mobile body 40 passes between the stationary obstacles 71 and 72.

FIG. 14 shows a speed pattern of the mobile body 40. For example, a speed pattern 1 shows that the mobile body 40 moves at a constant speed Vm without slowing down. A speed pattern 2 shows that the mobile body 40 slows down until it gets close to the moving route of the moving obstacle 73 and accelerates when it reaches the moving route of the moving obstacle 73 or exceeds the moving route of the moving obstacle 73. For example, the speed pattern 2 is one for the case where (i.e., one under the concept that) the moving obstacle 73 is made to pass the moving route of the mobile body 40 before the mobile body 40 reaches the moving route of the moving obstacle 73, and after the moving obstacle 73 passes the moving route of the mobile body 40, the mobile body 40 passes the moving route of the moving obstacle 73.

The speed pattern is not limited to those shown in FIG. 14. For example, the speed pattern may indicate that the speed of the mobile body 40 monotonically increases or monotonically decreases. Alternatively, the speed pattern may indicate that the speed of the mobile body 40 monotonically increases and then monotonically decreases. Further, the speeds in the speed patterns shown in FIG. 14 may be those determined based on the moving speed determined by the route control unit 22, or may be those set by an entity or the like disposed outside the control apparatus.

The evaluation unit 61 moves along the moving route shown in FIG. 12 according to Expression 4, and calculates, according to the below-shown Expression 5, the safety score of the mobile body 40 that is presumed (e.g., calculated) under the assumption that the mobile body 40 moves according to the speed pattern shown in FIG. 13.

$$J = {\sum }_{i} [ λ {v}_{i} {p}_{i} ( x , y , i ) + {( {v}_{i} - {v}_{m} )}^{2} ] \qquad ( 5 )$$

The symbol J represents a cost function. It indicates that the smaller the value of the cost function is, the higher the safety is. The symbol i represents a time step. The symbol vᵢ represents a predetermined speed in FIG. 13 at a time or timing indicated by the time step i. The symbol vₘ represents the constant speed in the speed pattern 1. The symbol vₘ may be the maximum speed of the mobile body 40. The symbol pᵢ(x,y,i) represents a probability of the presence of an obstacle in a cell of the grid including 2D coordinates of the mobile body 40 at the time or timing indicated by the time step i.

The value of the term λvᵢpᵢ(x,y,i), i.e., the first term on the right side, increases as the probability of the presence of an obstacle in the cell of the grid that the mobile body 40 passes increases or the speed of the mobile body 40 increases. In other words, the more the speed of the mobile body 40 is lowered, the more the value of the first term on the right side decreases. Therefore, it is possible to reduce the value of the cost function by reducing the speed of the mobile body 40. However, even though the value of the cost function is reduced and the safety is thereby improved by lowering the speed of the mobile body 40 as much as possible, the efficiency of the conveyance by the mobile body 40 deteriorates. Therefore, it is necessary to reduce the value of the cost function while taking the balance with the second term on the right side into consideration. The value of the term (vᵢ−vₘ)², i.e., the second term on the right side, increases as the speed is lowered relative to the constant speed vₘ. Note that a constant k is used as a parameter that indicates how much importance is put on the safety. Specifically, the more the value of λ is increased, the more the ratio of the value of the first term to the value of the cost function increases relative to the value of the second term, and the higher the safety becomes. Further, in places where the risk is low, such as a place where p in the first term is zero, the speed increases owing to the effect of the second term, which contributes to the improvement of the efficiency of the conveyance. The parameter λ may be, for example, set in advance by an operator, may be changed according to the degree of danger of the object to be conveyed (such as a fragile article or a weight), or may be changed according to the environmental conditions. Further, the parameter λ may be changed according to the shape of the cart on which the object to be conveyed is put or the height of the baggage or the like put thereon. Alternatively, an operator may set a candidate value of the parameter λ in advance, or conveyance data in the past may be stored (learned), and values of some of them which are found to be safe may be adopted later.

The evaluation unit 61 calculates cost functions that are presumed under the assumption that the mobile body 40 travels along a plurality of routes shown in FIG. 12 in the same speed pattern while taking the uncertainty of the moving route of the mobile body 40 into consideration. For example, the evaluation unit 61 may use the maximum value among the values of a plurality of cost functions calculated for the same speed pattern as the cost function for that speed pattern. Alternatively, the evaluation unit 61 may use other values such as an average value, a minimum value, or a median value, instead of the maximum value, as the cost function for the speed pattern.

The evaluation unit 61 compares the cost functions of the respective speed patterns, for example, those of the speed patterns 1 and 2 shown in FIG. 14, with each other, and determines a speed pattern corresponding to a low cost function, i.e., a speed pattern corresponding to high safety, as the speed pattern of the mobile body 40. The speed control unit 62 transmits the speed pattern determined by the evaluation unit 61 to the mobile body 40 and thereby controls the speed of the mobile body 40.

As described above, the control apparatus 60 according to the fourth example embodiment calculates a cost function for each of speed patterns for the mobile body 40 and for each of a plurality of cases where the mobile body 40 moves along different routes while taking the uncertainty of the moving route of the mobile body 40 into consideration. The mobile body 40 can reduce the possibility of a collision with an obstacle by moving according to the speed pattern determined based on the calculated cost function.

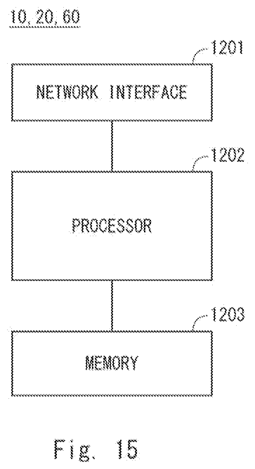

FIG. 15 is a block diagram showing an example of a configuration of each of the information processing apparatus 10, the control apparatus 20, and the control apparatus 60 (hereinafter referred to as the information processing apparatus 10 or the like). Referring to FIG. 15, the information processing apparatus 10 or the like includes a network interface 1201, a processor 1202, and a memory 1203. The network interface 1201 may be used to communicate with a network node (e.g., an eNB, an MME, or a P-GW). The network interface 1201 may include, for example, a network interface card (NIC) in conformity with IEEE 802.3 series. Note that the eNB represents an evolved Node B, the MME represents a Mobility Management Entity, and the P-GW represents a Packet Data Network Gateway. The IEEE stands for Institute of Electrical and Electronics Engineers.

The processor 1202 loads software (a computer program) from the memory 1203 and executes the loaded software, so that the processor 1202 performs the processes performed by the information processing apparatus 10 or the like described with reference to flowcharts in the above-described example embodiments. The processor 1202 may be, for example, a microprocessor, an MPU, or a CPU. The processor 1202 may include a plurality of processors.

The memory 1203 is composed of a combination of a volatile memory and a nonvolatile memory. The memory 1203 may include a storage remotely located from the processor 1202. In this case, the processor 1202 may access the memory 1203 through an I/O (Input/Output) interface (not shown).

In the example shown in FIG. 15, the memory 1203 is used to store a group of software modules. The processor 1202 loads the group of software modules (a computer program(s)) from the memory 1203 and executes the loaded software modules, so that the processor 1202 can perform the processes performed by the information processing apparatus 10 or the like described in the above-described example embodiment.

As described above with reference to FIG. 15, each of the processors included in the information processing apparatus 10 and the like in the above-described example embodiment executes one or a plurality of programs including a set of instructions for causing a computer to perform the algorithm described above with reference to the drawings.

In the above-described examples, the program includes a set of instructions (or software codes) that, when read into a computer, causes the computer to perform one or more of the functions described in the example embodiments. The program may be stored in a non-transitory computer readable medium or in a physical storage medium. By way of example rather than limitation, a computer readable medium or a physical storage medium may include a random-access memory (RAM), a read-only memory (ROM), a flash memory, a solid-state drive (SSD), or other memory technology, a CD-ROM, a digital versatile disc (DVD), a Blu-ray (registered trademark) disc or other optical disc storages, a magnetic cassette, magnetic tape, and a magnetic disc storage or other magnetic storage devices. The program may be transmitted on a transitory computer readable medium or a communication medium. By way of example rather than limitation, the transitory computer readable medium or the communication medium may include electrical, optical, acoustic, or other forms of propagating signals.

Note that the present disclosure is not limited to the above-described example embodiments, and they may be modified as appropriate without departing from the scope and spirit of the disclosure.

The whole or part of the example embodiments disclosed above can be described as, but not limited to, the following supplementary notes.

### Supplementary Note 1

An information processing apparatus comprising:
a communication unit configured to receive observation data from at least one sensor, the observation data being obtained by observing an obstacle in a plurality of areas;
a determination unit configured to determine presence/absence of an obstacle in the plurality of areas by using the observation data; and
a specifying unit configured to specify, when the presence/absence of an obstacle in a first area included in the plurality of areas is unknown, a probability of presence of an obstacle in the first area by using a determination result indicating presence/absence of an obstacle in an area near the first area, wherein
the probability of the presence of an obstacle in the first area changes depending on presence/absence of an obstacle in the area near the first area.

### Supplementary Note 2

The information processing apparatus described in Supplementary note 1, further comprising a label setting unit configured to set a label indicating whether or not there is an obstacle in the plurality of areas by using the determination result for each of the plurality of areas and the probability of the presence of an obstacle in the first area.

### Supplementary Note 3

The information processing apparatus described in Supplementary note 2, wherein
the plurality of areas are a plurality of cells of a grid generated by dividing a travelling area of a mobile body, and
the specifying unit calculates a probability of presence of an obstacle in a first cell of the grid where the observation data indicates that presence/absence of an obstacle is unknown.

### Supplementary Note 4

The information processing apparatus described in Supplementary note 3, wherein the specifying unit calculates the probability of the presence of an obstacle in the first cell of the grid by using a value of a weight that is used when the label is set to the first cell and a second cell adjacent to the first cell, the value of the weight being changed according to a determination result for the second cell.

### Supplementary Note 5

The information processing apparatus described in Supplementary note 3 or 4, wherein
the communication unit receives, after receiving observation data of the plurality of cells of the grid at a first time, observation data of the plurality of cells of the grid at a second time, and
the label setting unit determines whether or not there is a moving obstacle based on a transition in the determination result of each of the cells of the grid between the first and second times.

### Supplementary Note 6

The information processing apparatus described in Supplementary note 5, wherein the label setting unit determines, by using a value of a weight that is used when the label is set to a third cell of the grid at the first time, the third cell at the second time, or a cell adjacent to the third cell at the second time, whether or not there is a moving obstacle according to the determination result for the third cell of the grid at the first time and the determination result for the third cell or the cell adjacent to the third cell at the second time.

### Supplementary Note 7

The information processing apparatus described in any one of Supplementary notes 3 to 6, further comprising:
an evaluation unit configured to calculate a cost function indicating safety of travelling of the mobile body by using a speed pattern indicating a speed of the mobile body, a moving pattern indicating a moving route of the mobile body and indicated by using a probability model, and a probability of presence of an obstacle in each cell of the grid located on the moving route indicated by the moving pattern; and
a speed control unit configured to control the speed of the mobile body based on the calculated cost function.

### Supplementary Notes 8

A communication system comprising:
a sensor configured to observe an obstacle in a plurality of areas and transmit observation data indicating a result of the observation;
determination means for determining presence/absence of an obstacle in the plurality of areas by using the observation data; and
specifying means for specifying, when the presence/absence of an obstacle in a first area included in the plurality of areas is unknown, a probability of presence of an obstacle in the first area by using a determination result indicating presence/absence of an obstacle in an area near the first area, wherein
the probability of the presence of an obstacle in the first area changes depending on presence/absence of an obstacle in the area near the first area.

### Supplementary Note 9

The communication system described in Supplementary note 8, further comprising label setting means for setting a label indicating whether or not there is an obstacle in the plurality of areas by using the determination result for each of the plurality of areas and the probability of the presence of an obstacle in the first area.

### Supplementary Note 10

The communication system described in Supplementary note 9, wherein the plurality of areas are a plurality of cells of a grid generated by dividing a travelling area of a mobile body, and
the specifying means calculates a probability of presence of an obstacle in a first cell of the grid where the observation data indicates that presence/absence of an obstacle is unknown.

### Supplementary Note 11

The communication system described in Supplementary note 10, wherein the specifying means calculates the probability of the presence of an obstacle in the first cell of the grid by using a value of a weight that is used when the label is set to the first cell and a second cell adjacent to the first cell, the value of the weight being changed according to a determination result for the second cell.

### Supplementary Note 12

The communication system described in Supplementary note 10 or 11, further comprising communication means for receiving, after receiving observation data of the plurality of cells of the grid at a first time, observation data of the plurality of cells of the grid at a second time, wherein
the label setting means determines whether or not there is a moving obstacle based on a transition in the determination result of each of the cells of the grid between the first and second times.

### Supplementary Note 13

The communication system described in Supplementary note 12, wherein
the label setting means sets a label indicating that there is a stationary obstacle, there is a moving obstacle, or there is no obstacle in each cell of the grid, and
the label setting means determines, by using a value of a weight that is used when the label is set to a third cell of the grid at the first time, the third cell at the second time, or a cell adjacent to the third cell at the second time, whether or not there is a moving obstacle according to the determination result for the third cell of the grid at the first time and the determination result for the third cell or the cell adjacent to the third cell at the second time.

### Supplementary Note 14

The communication system described in any one of Supplementary notes 10 to 13, further comprising:
evaluation means for calculating a cost function indicating safety of travelling of the mobile body by using a speed pattern indicating a speed of the mobile body, a moving pattern indicating a moving route of the mobile body and indicated by using a probability model, and a probability of presence of an obstacle in each cell of the grid located on the moving route indicated by the moving pattern; and
speed control means for controlling the speed of the mobile body based on the calculated cost function.

### Supplementary Notes 15

A specifying method comprising:
receiving observation data from at least one sensor, the observation data being obtained by observing an obstacle in a plurality of areas;
determining presence/absence of an obstacle in the plurality of areas by using the observation data; and
specifying, when the presence/absence of an obstacle in a first area included in the plurality of areas is unknown, a probability of presence of an obstacle in the first area by using a determination result indicating presence/absence of an obstacle in an area near the first area, wherein
the probability of the presence of an obstacle in the first area changes depending on presence/absence of an obstacle in the area near the first area.

### Supplementary Note 16

The specifying method described in Supplementary note 15, further comprising setting a label indicating whether or not there is an obstacle in the plurality of areas by using the determination result for each of the plurality of areas and the probability of the presence of an obstacle in the first area.

### Supplementary Note 17

The specifying method described in Supplementary note 16, wherein the plurality of areas are a plurality of cells of a grid generated by dividing a travelling area of a mobile body, and
when a probability of presence of an obstacle is specified, a probability of presence of an obstacle in a first cell of the grid where the observation data indicates that presence/absence of an obstacle is unknown is calculated.

### Supplementary Note 18

The specifying method described in Supplementary note 17, wherein when a probability of presence of an obstacle is specified, a probability of presence of an obstacle in the first cell of the grid is calculated by using a value of a weight that is used when the label is set to the first cell and a second cell adjacent to the first cell, the value of the weight being changed according to a determination result for the second cell.

### Supplementary Note 19

The specifying method described in Supplementary note 17 or 18, wherein
when the observation data is received, after observation data of the plurality of cells of the grid at a first time is received, observation data of the plurality of cells of the grid at a second time is received, and
whether or not there is a moving obstacle is determined based on a transition in the determination result of each of the cells of the grid between the first and second times.

### Supplementary Note 20

The specifying method described in Supplementary note 19, wherein when the label is set, whether or not there is a moving obstacle is determined, by using a value of a weight that is used when the label is set to a third cell of the grid at the first time, the third cell at the second time, or a cell adjacent to the third cell at the second time, according to the determination result for the third cell of the grid at the first time and the determination result for the third cell or the cell adjacent to the third cell at the second time.

### (Supplementary Note 21)

A program for causing a computer to perform:
receiving observation data from at least one sensor, the observation data being obtained by observing an obstacle in a plurality of areas;
determining presence/absence of an obstacle in the plurality of areas by using the observation data; and
specifying, when the presence/absence of an obstacle in a first area included in the plurality of areas is unknown, a probability of presence of an obstacle in the first area by using a determination result indicating presence/absence of an obstacle in an area near the first area, wherein
the probability of the presence of an obstacle in the first area changes depending on presence/absence of an obstacle in the area near the first area.

Although the present invention is described above with reference to example embodiments, the present invention is not limited to the above-described example embodiments.

Various modifications that can be understood by those skilled in the art can be made to the configuration and details of the present invention within the scope and spirit of the invention.

This application is based upon and claims the benefit of priority from Japanese patent application No. 2021-140626, filed on Aug. 31, 2021, the disclosure of which is incorporated herein its entirety by reference.

### REFERENCE SIGNS LIST

10 INFORMATION PROCESSING APPARATUS
11 COMMUNICATION UNIT
12 DETERMINATION UNIT
13 SPECIFYING UNIT
20 CONTROL APPARATUS
21 LABEL SETTING UNIT
22 ROUT CONTROL UNIT
30 SENSOR
31 SENSOR
32 SENSOR
33 SENSOR
40 MOBILE BODY
50 NETWORK
60 CONTROL APPARATUS
61 EVALUATION UNIT
62 SPEED CONTROL UNIT
71 OBSTACLE
72 OBSTACLE
73 OBSTACLE

What is claimed is:

1. An information processing apparatus comprising:
at least one memory storing instructions, and
at least one processor configured to execute the instructions to;
receive observation data from at least one sensor, the observation data being obtained by observing an obstacle in a plurality of areas;
determine presence/absence of an obstacle in the plurality of areas by using the observation data; and
specify, when the presence/absence of an obstacle in a first area included in the plurality of areas is unknown, a probability of presence of an obstacle in the first area by using a determination result indicating presence/absence of an obstacle in an area near the first area, wherein
the probability of the presence of an obstacle in the first area changes depending on presence/absence of an obstacle in the area near the first area.

2. The information processing apparatus according to claim 1, wherein the at least one processor is further configured to execute the instructions to set a label indicating whether or not there is an obstacle in the plurality of areas by using the determination result for each of the plurality of areas and the probability of the presence of an obstacle in the first area.

3. The information processing apparatus according to claim 2, wherein
the plurality of areas are a plurality of cells of a grid generated by dividing a travelling area of a mobile body, and
the at least one processor is further configured to execute the instructions to calculate a probability of presence of an obstacle in a first cell of the grid where the observation data indicates that presence/absence of an obstacle is unknown.

4. The information processing apparatus according to claim 3, wherein the at least one processor is further configured to execute the instructions to calculate the probability of the presence of an obstacle in the first cell of the grid by using a value of a weight that is used when the label is set to the first cell and a second cell adjacent to the first cell, the value of the weight being changed according to a determination result for the second cell.

5. The information processing apparatus according to claim 3, wherein the at least one processor is further configured to execute the instructions to
receive, after receiving observation data of the plurality of cells of the grid at a first time, observation data of the plurality of cells of the grid at a second time, and
determine whether or not there is a moving obstacle based on a transition in the determination result of each of the cells of the grid between the first and second times.

6. The information processing apparatus according to claim 5, wherein the at least one processor is further configured to execute the instructions to determine, by using a value of a weight that is used when the label is set to a third cell of the grid at the first time, the third cell at the second time, or a cell adjacent to the third cell at the second time, whether or not there is a moving obstacle according to the determination result for the third cell of the grid at the first time and the determination result for the third cell or the cell adjacent to the third cell at the second time.

7. The information processing apparatus according to claim 3, wherein the at least one processor is further configured to execute the instructions to
calculate a cost function indicating safety of travelling of the mobile body by using a speed pattern indicating a speed of the mobile body, a moving pattern indicating a moving route of the mobile body and indicated by using a probability model, and a probability of presence of an obstacle in each cell of the grid located on the moving route indicated by the moving pattern; and
control the speed of the mobile body based on the calculated cost function.

8. A communication system comprising:
at least one memory storing instructions, and
at least one processor configured to execute the instructions to;
observe an obstacle in a plurality of areas and transmit observation data indicating a result of the observation;
determine presence/absence of an obstacle in the plurality of areas by using the observation data; and
specify, when the presence/absence of an obstacle in a first area included in the plurality of areas is unknown, a probability of presence of an obstacle in the first area by using a determination result indicating presence/absence of an obstacle in an area near the first area, wherein
the probability of the presence of an obstacle in the first area changes depending on presence/absence of an obstacle in the area near the first area.

9. The communication system according to claim 8, wherein the at least one processor is further configured to execute the instructions to set a label indicating whether or not there is an obstacle in the plurality of areas by using the determination result for each of the plurality of areas and the probability of the presence of an obstacle in the first area.

10. The communication system according to claim 9, wherein
the plurality of areas are a plurality of cells of a grid generated by dividing a travelling area of a mobile body, and
the at least one processor is further configured to execute the instructions to calculate a probability of presence of an obstacle in a first cell of the grid where the observation data indicates that presence/absence of an obstacle is unknown.

11. The communication system according to claim 10, wherein the at least one processor is further configured to execute the instructions to calculate the probability of the presence of an obstacle in the first cell of the grid by using a value of a weight that is used when the label is set to the first cell and a second cell adjacent to the first cell, the value of the weight being changed according to a determination result for the second cell.

12. The communication system according to claim 10, wherein the at least one processor is further configured to execute the instructions to receive, after receiving observation data of the plurality of cells of the grid at a first time, observation data of the plurality of cells of the grid at a second time; and
determine whether or not there is a moving obstacle based on a transition in the determination result of each of the cells of the grid between the first and second times.

13. The communication system according to claim 12, wherein the at least one processor is further configured to execute the instructions to
set a label indicating that there is a stationary obstacle, there is a moving obstacle, or there is no obstacle in each cell of the grid, and
determine, by using a value of a weight that is used when the label is set to a third cell of the grid at the first time, the third cell at the second time, or a cell adjacent to the third cell at the second time, whether or not there is a moving obstacle according to the determination result for the third cell of the grid at the first time and the determination result for the third cell or the cell adjacent to the third cell at the second time.

14. The communication system according to claim 10, wherein the at least one processor is further configured to execute the instructions to:
calculate a cost function indicating safety of travelling of the mobile body by using a speed pattern indicating a speed of the mobile body, a moving pattern indicating a moving route of the mobile body and indicated by using a probability model, and a probability of presence of an obstacle in each cell of the grid located on the moving route indicated by the moving pattern; and
control the speed of the mobile body based on the calculated cost function.

15. A specifying method comprising:
receiving observation data from at least one sensor, the observation data being obtained by observing an obstacle in a plurality of areas;
determining presence/absence of an obstacle in the plurality of areas by using the observation data; and
specifying, when the presence/absence of an obstacle in a first area included in the plurality of areas is unknown, a probability of presence of an obstacle in the first area by using a determination result indicating presence/absence of an obstacle in an area near the first area, wherein
the probability of the presence of an obstacle in the first area changes depending on presence/absence of an obstacle in the area near the first area.

16. The specifying method according to claim 15, further comprising setting a label indicating whether or not there is an obstacle in the plurality of areas by using the determination result for each of the plurality of areas and the probability of the presence of an obstacle in the first area.

17. The specifying method according to claim 16, wherein
the plurality of areas are a plurality of cells of a grid generated by dividing a travelling area of a mobile body, and
when a probability of presence of an obstacle is specified, a probability of presence of an obstacle in a first cell of the grid where the observation data indicates that presence/absence of an obstacle is unknown is calculated.

18. The specifying method according to claim 17, wherein when a probability of presence of an obstacle is specified, a probability of presence of an obstacle in the first cell of the grid is calculated by using a value of a weight that is used when the label is set to the first cell and a second cell adjacent to the first cell, the value of the weight being changed according to a determination result for the second cell.

19. The specifying method according to claim 17, wherein
when the observation data is received, after observation data of the plurality of cells of the grid at a first time is received, observation data of the plurality of cells of the grid at a second time is received, and
whether or not there is a moving obstacle is determined based on a transition in the determination result of each of the cells of the grid between the first and second times.

20. The specifying method according to claim 19, wherein when the label is set, whether or not there is a moving obstacle is determined, by using a value of a weight that is used when the label is set to a third cell of the grid at the first time, the third cell at the second time, or a cell adjacent to the third cell at the second time, according to the determination result for the third cell of the grid at the first time and the determination result for the third cell or the cell adjacent to the third cell at the second time.

21. (canceled)
